(19) United States
(12) Patent Application Publication
(10) Pub. No.: US 2025/0374905 A1
(43) Pub. Date: Dec. 11, 2025

(54) DUAL-BEARING REEL

(71) Applicant: Shimano Inc., Osaka (JP)

(72) Inventors: Kohei NAKAMURA, Osaka (JP); Hiroki OOGOSE, Osaka (JP); Shouji NAKAGAWA, Osaka (JP); Hitoshi HARAGUCHI, Osaka (JP); Satoshi MURAYAMA, Osaka (JP); Youhei TOAKE, Osaka (JP); Takuya YASHIKI, Osaka (JP); Hirotaka HONDA, Osaka (JP)

(21) Appl. No.: 19/226,861

(22) Filed: Jun. 3, 2025

(30) Foreign Application Priority Data
Jun. 10, 2024 (JP) 2024-094000

(51) Int. Cl. A01K 89/015; F16C 33/58; F16C 33/76

(52) U.S. Cl. CPC A01K 89/0193; A01K 89/0186; F16C 33/581; F16C 33/768; F16C 2316/30

(57) ABSTRACT

A dual bearing reel includes a reel body, a handle rotatably supported by the reel body, a spool shaft rotatably supported by the reel body, a spool to integrally rotate with the spool shaft, a pinion gear to move between a transmitting position to transmit a rotational force of the handle to the spool shaft and a disengaged position to prevent transmission of the rotational force of the handle to the spool shaft, a clutch control mechanism to move the pinion gear between the transmitting position and the disengaged position, and a bearing rotatably supporting the pinion gear relative to the reel body and to move together with the pinion gear when the pinion gear moves between the transmitting position and the disengaged position.

### CROSS-REFERENCE TO RELATED APPLICATIONS

This application claims priority to Japanese Patent Application No. 2024-094000, filed on Jun. 10, 2024. The entire disclosure of Japanese Patent Application No. 2024-094000 is hereby incorporated by reference.

### BACKGROUND

### Technical Field

The present disclosure relates to a dual-bearing reel.

### Background Information

A conventional dual-bearing reel comprises a reel body, a handle, a spool shaft, a spool, a pinion gear, and a clutch control mechanism (refer to Japanese Patent No. 7257488). The pinion gear is rotatably supported by a bearing that is attached to the reel body. The pinion gear is able to move relative to the bearing between a transmitting (or engaged) position in which the rotational force of the handle is transmitted to the spool shaft and a disengaged position in which the transmission of the rotational force of the handle is not transmitted to the spool shaft. The clutch control mechanism moves the pinion gear between the transmitting position and the disengaged position.

In a conventional dual-bearing reel, the pinion gear is rotatably supported by a bearing. In this case, the outer race of the bearing is attached to the reel body. In this state, when the clutch control mechanism is actuated, the pinion gear moves between the transmitting position and the disengaged position with respect to the inner race of the bearing.

### SUMMARY

It has been determined that in this configuration, if electrolytic water such as salt water enters between the inner race of the bearing and the outer circumferential surface of the pinion gear, there is the risk that the inner race of the bearing and the outer circumferential surface of the pinion gear are oxidized due to electrolysis. Here, if the inner race of the bearing and the outer circumferential surface of the pinion gear oxidize, there is the risk that the outer circumferential surface of the pinion gear and the inner race of the bearing will adhere to each other. In this case, it is difficult to smoothly move the pinion gear in the axial direction with respect to the inner race of the bearing.

Accordingly, it is an object of the present disclosure is to provide a dual-bearing reel that can smoothly move the pinion gear.

With regard to a first aspect of the present disclosure, a dual-bearing reel comprises a reel body, a handle, a spool shaft, a spool, a pinion gear, a clutch control mechanism, and a bearing. The handle is rotatably supported by the reel body. The spool shaft is rotatably supported by the reel body. The spool rotates integrally with the spool shaft.

The pinion gear is able to move between a transmitting position in which the rotational force of the handle is transmitted to the spool shaft and a disengaged position in which the rotational force of the handle is prevented or not transmitted to the spool shaft. The clutch control mechanism moves the pinion gear between the transmitting position and the disengaged position. The bearing rotatably supports the pinion gear with respect to the reel body. When the pinion gear moves between the transmitting position and the disengaged position, the bearing moves together with the pinion gear.

In a dual-bearing reel according to a first aspect, the bearing moves together with the pinion gear while the pinion gear moves between the transmitting position and the disengaged position, so that it is not necessary to provide a gap between the inner race of the bearing and the outer circumferential surface of the pinion gear. Therefore, it is possible to prevent electrolytic water from entering between the inner race of the bearing and the outer circumferential surface of the pinion gear. That is, the present disclosure can prevent the outer circumferential surface of the pinion gear and the inner race of the bearing from adhering to each other. It is thereby possible to smoothly move the pinion gear.

A dual-bearing reel relating to a second aspect, according to the first aspect of the present disclosure, further comprises a sliding member. The sliding member is disposed between the reel body and the bearing.

In the dual-bearing reel according to the second aspect, since the sliding member is disposed between the reel body and the bearing, the bearing can be smoothly moved together with the pinion gear.

A dual-bearing reel according to a third aspect, according to the first or second aspects of the present disclosure, further comprises a biasing member. The biasing member biases the bearing when the bearing moves together with the pinion gear.

In the dual-bearing reel according to the third aspect, since the biasing member biases the bearing, the bearing can be smoothly moved together with the pinion gear.

A dual-bearing reel according to a fourth aspect, according to any one of the first to the third aspects of the present disclosure, further comprises a waterproofing member. The waterproofing member is provided on the pinion gear and prevents ingress of water into the bearing.

In the dual-bearing reel according to the fourth aspect, the waterproofing member can prevent ingress of water into the inside of the bearing. That is, the bearing can be smoothly rotated.

A dual-bearing reel according to a fifth aspect, according to any one of the first to the fourth aspects of the present disclosure, is configured as follows. The bearing comprises an inner race, an outer race, and rolling elements. The inner race is supported by the pinion gear. When the pinion gear moves between the transmitting position and the disengaged position, the outer race is supported so as to be slidable with respect to the reel body. The rolling elements are provided between the inner race and the outer race. The rolling elements rotatably support the inner race and the outer race relative to each other.

A dual-bearing reel relating to a sixth aspect, according to the fifth aspect of the present disclosure, further comprises a sliding member. The sliding member is disposed between the reel body and the outer race of the bearing.

In the dual-bearing reel according to the sixth aspect, since the sliding member is disposed between the reel body and the outer race of the bearing, the bearing can be smoothly moved together with the pinion gear.

A dual-bearing reel according to a seventh aspect, according to any one of the first to the sixth aspects of the present disclosure, further comprises a biasing member. The biasing member biases the outer race of the bearing in a direction from the disengaged position toward the transmitting position, when the bearing moves together with the pinion gear.

In the dual-bearing reel according to the seventh aspect, since the biasing member biases the outer race of the bearing in the direction described above, the bearing can be more smoothly moved together with the pinion gear.

A dual-bearing reel according to an eighth aspect, according to any one of the first to the seventh aspects of the present disclosure, is configured as follows. The pinion gear comprises a gear portion and a transmission portion. The rotation of the handle is transmitted to the gear portion when positioned in the transmitting position. The transmission portion transmits the rotation of the pinion gear to the spool shaft when positioned in the transmitting position. The bearing includes a first bearing provided at a first end of the pinion gear on the gear portion side.

The dual-bearing reel according to the eighth aspect has the following effect. Generally, in a clutch-on state, external force from the main gear acts on the gear portion of the pinion gear. For this reason, as the axial distance between the first bearing and the gear portion of the pinion gear decreases, the pinion gear can be more stably rotated.

However, in the prior art, when the pinion gear is positioned in the transmitting position, the gear portion of the pinion gear separates away from the first bearing in the axial direction, so there is the risk that stability of the rotation of the pinion gear decreases.

In contrast, in the present dual-bearing reel, since the first bearing is provided at the first end of the pinion gear on the gear portion side, the first bearing moves in the axial direction together with the pinion gear in a state of being adjacent to the gear portion of the pinion gear. This allows the pinion gear to rotate stably when the pinion gear is positioned in the transmitting position.

A dual-bearing reel according to a ninth aspect, according to any one of the first to the eighth aspects of the present disclosure, is configured as follows. The pinion gear comprises a gear portion and a transmission portion. The rotation of the handle is transmitted to the gear portion when positioned in the transmitting position. The transmission portion transmits the rotation of the pinion gear to the spool shaft when positioned in the transmitting position. The bearing includes a second bearing provided at a second end of the pinion gear on the transmission portion side.

In the dual-bearing reel according to the ninth aspect, since the second bearing is provided at the second end of the pinion gear on the transmission portion side, the pinion gear can be stably rotated by the first bearing and the second bearing.

### BRIEF DESCRIPTION OF THE DRAWINGS

FIG. 1 is a side view of a dual-bearing reel employing a first embodiment of the present disclosure.

FIG. 2 is a cross-section diagram taken along the section line II in FIG. 1.

FIG. 3 is a cross-section diagram for explaining the configuration of a spool shaft and a pinion gear.

FIG. 4A is a cross-section diagram of the periphery of the pinion gear when the pinion gear is positioned in the transmitting position.

FIG. 4B is a cross-section diagram of the periphery of the pinion gear when the pinion gear is positioned in the disengaged position.

FIG. 5 is a cross-section diagram for explaining a modified example A.

FIG. 6 is a cross-section diagram for explaining a modified example B.

### DETAILED DESCRIPTION

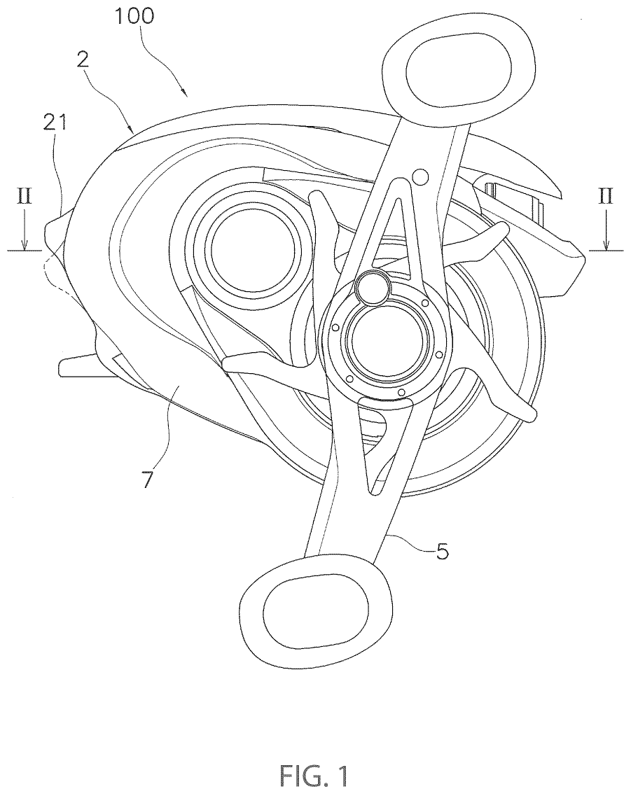

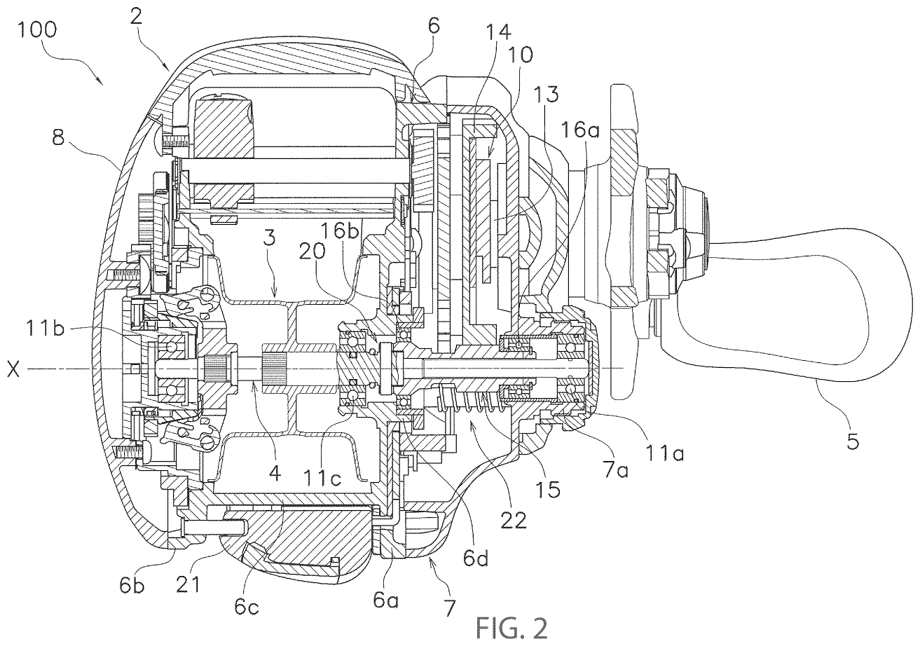

As shown in FIGS. 1 and 2, a dual bearing reel 100 in which one embodiment of the present disclosure is employed comprises a reel body 2, a spool 3, a spool shaft 4, a handle 5, a rotation transmission mechanism (rotation transmitter) 10, a clutch mechanism (clutch0 20, and a clutch control mechanism (clutch controller) 22. FIG. 1 is a side view of the reel body 2 as seen from the handle 5 side.

In the following description, the direction in which a fishing line is cast (unreeled) during fishing is defined as the forward direction, and the direction opposite to the forward direction is defined as the rearward direction. The left-right direction is the left-right direction when viewing the dual-bearing reel 100 from the rear. The direction in which the spool shaft 4 extends is defined as the axial direction. The direction perpendicular to the direction in which the spool shaft 4 extends is defined as the radial direction. The direction around the spool shaft 4 is defined as the circumferential direction.

As shown in FIG. 2, the reel body 2 comprises a frame 6, a first side cover 7, and a second side cover 8. The frame 6 has a first side plate 6a, a second side plate 6b, and a plurality of connecting portions 6c. The first side plate 6a is disposed on the right side of the frame 6. The first side plate 6a has a first boss 6d.

The second side plate 6b is disposed on the left side of the frame 6, spaced apart from the first side plate 6a in the axial direction. The plurality of connecting portions 6c extend in the axial direction and connect the first side plate 6a and the second side plate 6b. The first side cover 7 covers the right side of the first side plate 6a of the frame 6. The first side cover 7 has s second boss 7a. The second boss 7a protrudes in the axial direction from the outer surface of the first side cover 7. The second side cover 8 covers the left side of the second side plate 6b of the frame 6.

As shown in FIG. 2, the spool 3 is disposed between the first side plate 6a and the second side plate 6b. The spool 3 is connected to the spool shaft 4 so as to integrally rotate with the spool shaft 4. The spool 3 is rotatably supported with respect to the reel body 2 via the spool shaft 4. The spool shaft 4 extends inside the reel body 2 in the axial direction. The spool shaft 4 is rotatably supported by the reel body 2 via bearings 11a, 11b, 11c provided in the reel body 2.

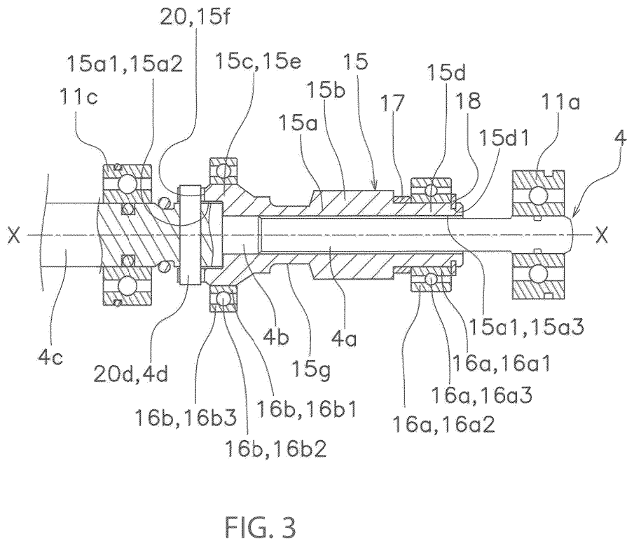

As shown in FIG. 3, the spool shaft 4 has a first shaft portion 4a, a second shaft portion 4b, and a third shaft portion 4c. The first shaft portion 4a extends inside the first side cover 7 in the axial direction (refer to FIG. 2). The second shaft portion 4b has a larger diameter than the outer diameter of the first shaft portion 4a and is formed adjacent to the first shaft portion 4a. The third shaft portion 4c has a larger diameter than the outer diameter of the second shaft portion 4b and is formed adjacent to the second shaft portion 4b.

An engagement pin 4d is fixed to the third shaft portion 4c. The engagement pin 4d penetrates the third shaft portion 4c in the radial direction. Both ends of the third shaft portion 4c protrude in the radial direction from the outer circumferential surface of the spool shaft 4. The engagement pin 4d can be considered as or part of the clutch mechanism 20.

As shown in FIGS. 1 and 2, the handle 5 is rotatable relative to the reel body 2 and is rotatably supported by the reel body 2. The rotation of the handle 5 is transmitted to a drive gear 14 via a drive shaft 13. As shown in FIG. 2, the rotation transmission mechanism 10 transmits the rotation of the handle 5 to the spool 3. The rotation transmission mechanism 10 comprises the drive shaft 13, the drive gear 14, and a pinion gear 15.

As shown in FIG. 2, the drive shaft 13 is connected to the handle 5 so as to integrally rotate with the handle 5. The drive shaft 13 is rotated only in the line-winding direction (reeling direction) by a one-way clutch (not shown) that is disposed on the outer perimeter of the drive shaft 13. The drive gear 14 is attached to the drive shaft 13. The rotation of the handle 5 is transmitted to the drive gear 14 via a drag mechanism (not shown) that is disposed inside the first side cover 7.

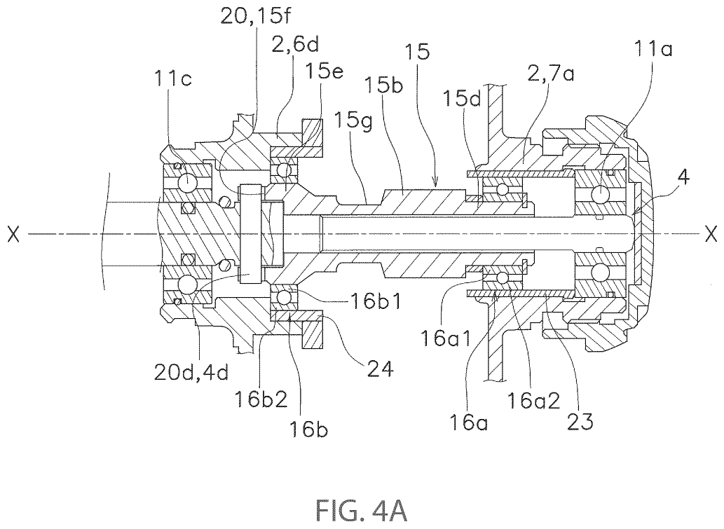

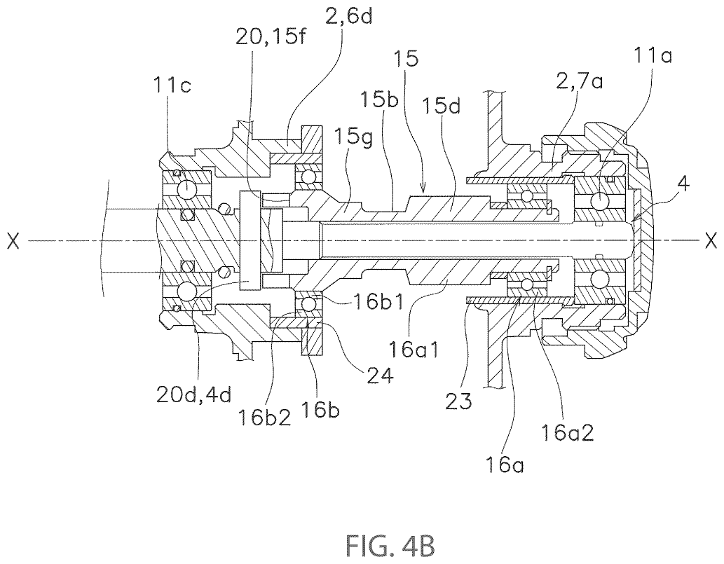

As shown in FIGS. 4A and 4B, the pinion gear 15 is able to move between a transmitting position (refer to FIG. 4A) in which the rotational force of the handle 5 is transmitted to the spool shaft 4 and a disengaged position (refer to FIG. 4B) in which the rotational force of the handle 5 is prevented or not transmitted to the spool shaft 4.

FIG. 4A shows a case in which the pinion gear 15 is positioned in the transmitting position. In the transmitting position, the pinion gear 15 is connected to the spool shaft 4 so as to integrally rotate with the spool shaft 4. This state is the transmitting state in which the rotational force of the handle 5 is transmitted to the spool 3. In the transmitting state, a clutch mechanism 20, described further below, is in the ON state.

FIG. 4B shows a case in which the pinion gear 15 is positioned in the disengaged position. In the disengaged position, the connection with the spool shaft 4 is disengaged. This state is the disengaged state in which the rotational force of the handle 5 is not transmitted to the spool 3. In the disengaged state, the clutch mechanism 20 is in the OFF state.

As shown in FIG. 2, the pinion gear 15 meshes with the drive gear 14. The rotational axis X of the pinion gear 15 is concentric with the rotational axis of the spool shaft 4. As shown in FIG. 3, the pinion gear 15 has a tubular body portion 15a, a gear portion 15b, and a transmission portion 15c.

The body portion 15a is formed in a tubular shape, and the spool shaft 4 is disposed in the inner circumferential part of the body portion 15a. The inner circumferential surface of the body portion 15a forms a through-hole 15a1. The through-hole 15a1 is a hole extending in the axial direction.

As shown in FIG. 3, the through-hole 15a1 has a large-diameter hole portion 15a2 and a small-diameter hole portion 15a3. The inner diameter of the large-diameter hole portion 15a2 is larger than the outer diameter of the third shaft portion 4c of the spool shaft 4. When the pinion gear 15 is in the transmitting position, an end portion of the third shaft portion 4c is disposed in the large-diameter hole portion 15a2.

The small-diameter hole portion 15a3 is adjacent to the large-diameter hole portion 15a2. The internal diameter of the small-diameter hole portion 15a3 is smaller than the outer diameter of the third shaft portion 4c of the spool shaft 4. In addition, the inner diameter of the small-diameter hole portion 15a3 is larger than the outer diameter of first shaft portion 4a and the second shaft portion 4b of the spool shaft 4. When the pinion gear 15 is positioned in the transmitting position, the first shaft portion 4a of the spool shaft 4 and the second shaft portion 4b of the spool shaft 4 are disposed in the small-diameter hole portion 15a3.

When the pinion gear 15 is positioned in the transmitting position, the rotational force of the handle 5 is transmitted to the gear portion 15b shown in FIG. 3. More specifically, as shown in FIG. 2, when the pinion gear 15 is positioned in the transmitting position, the gear portion 15b meshes with the drive gear 14, and the rotational force of the handle 5 is transmitted to the gear portion 15b.

As shown in FIG. 3, the gear portion 15b is provided on the outer circumferential portion of the body portion 15a. The gear portion 15b is provided between a first end 15d of the body portion 15a and a second end 15e of the body portion 15a. The first end 15d (one example of a first end on the gear portion side) protrudes in the axial direction from the gear portion 15b toward the handle 5. The second end 15e is (one example of a second end on the transmission portion side) on the side opposite to the first end 15d.

As shown in FIG. 3, when the pinion gear 15 is positioned in the transmitting position, the transmission portion 15c transmits the rotation of the pinion gear 15 to the spool shaft 4. The transmission portion 15c is disposed spaced apart from the gear portion 15b in the axial direction and forms the second end 15e of the body portion 15a. The transmission portion 15c has an engagement recess 15f. In the present embodiment, the engagement recess 15f includes a pair of engagement recesses 15f.

As shown in FIG. 3, the pair of engagement recesses 15f are provided at an end surface of the second end 15e, for example, on an end surface of the transmission portion 15c. The pair of engagement recesses 15f are each disposed facing each other in the radial direction, and are formed so as to be recessed in the axial direction from the end surface of the transmission portion 15c. The pair of engagement recesses 15f engage with the engagement pin 4d when the pinion gear 15 is positioned in the transmitting position. The pair of engagement recesses 15f is a part of the configuration of the clutch mechanism 20. The clutch control mechanism 22 shown in FIG. 2 engages with a recess 15g provided between the gear portion 15b and the transmission portion 15c.

As shown in FIG. 3, the pinion gear 15 is rotatably supported by a first bearing 16a and a second bearing 16b. The first bearing 16a and the second bearing 16b rotatably support the pinion gear 15 relative to the reel body 2. As shown in FIGS. 4A and 4B, when the pinion gear 15 moves between the transmitting position and the disengaged position, the first bearing 16a and the second bearing 16b move together with the pinion gear 15.

As shown in FIG. 3, the first bearing 16a is provided at the first end 15d of the pinion gear 15. Specifically, the first bearing 16a is disposed adjacent to the gear portion 15b in the axial direction. The first bearing 16a is provided on the outer circumferential surface of the first end 15d so as to be able to move integrally with the pinion gear 15 in the axial direction.

As shown in FIGS. 4A and 4B, the first bearing 16a is disposed, in the radial direction, between the reel body 2 and the first end 15d of the pinion gear 15. Specifically, the first bearing 16a is disposed, in the radial direction, between the first end 15d of the pinion gear 15 and the second boss 7a of the first side cover 7.

As shown in FIG. 3, the first bearing 16a has a first inner race 16a1, a first outer race 16a2, and a first rolling element 16a3. The first inner race 16a1 is supported by the pinion gear 15. Specifically, the first inner race 16a1 is disposed on the outer circumferential surface of the first end 15d of the pinion gear 15. The first inner race 16a1 is disposed adjacent to the gear portion 15b in the axial direction. A positioning member 17 is disposed between the first inner race 16a1 and the gear portion 15b in the axial direction.

As shown in FIG. 3, a retaining member 18 is configured to prevent the first inner race 16a1 from falling off or disengaging. In the present embodiment, the retaining member 18 is a C-shaped retaining ring. The retaining member 18 is disposed in an annular recess 15d1 provided on the outer circumferential surface of the first end 15d of the pinion gear 15. With this configuration, the first bearing 16a is restricted from falling off of the first end 15d of the pinion gear 15.

As shown in FIGS. 4A and 4B, the first outer race 16a2 is disposed radially inward of the inner circumferential surface of the second boss 7a of the first side cover 7. When the pinion gear 15 moves between the transmitting position and the disengaged position, the first outer race 16a2 is supported so as to be slidable relative to the reel body 2. In the present embodiment, the first outer race 16a2 is supported so as to be slidable relative to the reel body 2 via a first sliding member 23, described further below.

As shown in FIG. 3, the first rolling element 16a3 is provided between the first inner race 16a1 and the first outer race 16a2. The first rolling element 16a3 supports the first inner race 16a1 and the first outer race 16a2 so as to be rotatable relative to each other.

As shown in FIG. 3, the second bearing 16b is provided at the second end 15e of the pinion gear 15. The second bearing 16b is provided on the outer circumferential surface of the second end portion 15e so as to be able to move integrally with the pinion gear 15 in the axial direction.

As shown in FIGS. 4A and 4B, the second bearing 16b is disposed, in the radial direction, between the reel body 2 and the second end 15e of the pinion gear 15. Specifically, the second bearing 16b is disposed, in the radial direction, between the second end 15e of the pinion gear 15 and the first boss 6d of the first side plate 6a.

As shown in FIG. 3, the second bearing 16b has a second inner race 16b1, a second outer race 16b2, and a second rolling element 16b3. The second inner race 16b1 is supported by the pinion gear 15. Specifically, the second inner race 16b1 is press-fitted and fixed to the outer circumferential surface of the second end portion 15e of the pinion gear 15. The method of fixing the second inner race 16b1 can be any other suitable fixing method.

As shown in FIGS. 4A and 4B, the second outer race 16b2 is disposed radially inward of the inner circumferential surface of the first boss 6d of the first side plate 6a. When the pinion gear 15 moves between the transmitting position and the disengaged position, the second outer race 16b2 is supported so as to be slidable relative to the reel body 2. In the present embodiment, the second outer race 16b2 is supported so as to be slidable relative to the reel body 2 via a second sliding member 24, described further below.

As shown in FIG. 3, the second rolling element 16b3 is provided between the second inner race 16b1 and the second outer race 16b2. The second rolling element 16b3 supports the second inner race 16b1 and the second outer race 16b2 so as to be rotatable relative to each other.

As shown in FIGS. 4A and 4B, the first sliding member 23 is disposed between the first bearing 16a and the reel body 2. The first sliding member 23 is formed in a tubular shape. The first sliding member 23 is preferably a collar member made of resin. The first sliding member 23 is disposed, in the radial direction, between the reel body 2 and the first outer race 16a2 of the first bearing 16a.

Specifically, the first sliding member 23 is disposed, in the radial direction, between the first outer race 16a2 of the first bearing 16a and the inner circumferential surface of the second boss 7a of the first side cover 7. The first engagement portion 23 is fixed, by elastic engagement, to the inner circumferential surface of the second boss 7a of the first side cover 7. The method of fixing the first sliding member 23 can be any other suitable fixing method. The outer circumferential surface of the first outer race 16a2 of the first bearing 16a contacts the inner circumferential surface of the first sliding member 23.

As shown in FIGS. 4A and 4B, the second sliding member 24 is disposed between the second bearing 16b and the reel body. The second sliding member 24 is formed in a tubular shape. The second sliding member 24 is preferably a collar member made of resin. The second sliding member 24 is disposed, in the radial direction, between the reel body 2 and the second outer race 16b2 of the second bearing 16b.

Specifically, the second sliding member 24 is disposed, in the radial direction, between the second outer race 16b2 of the second bearing 16b and the inner circumferential surface of the first boss 6d of the first side plate 6a. The second sliding member 24 is press-fitted and fixed to the inner circumferential surface of the first boss 6d of the first side plate 6a. The method of fixing the second sliding member 24 can be any other suitable fixing method. The outer circumferential surface of the second outer race 16b2 of the second bearing 16b contacts the inner circumferential surface of the second sliding member 24.

The clutch mechanism 20 shown in FIG. 2 is a mechanism for transmitting and disengaging the rotational force from the handle 5 to the spool 3. As shown in FIGS. 4A and 4B, the clutch mechanism 20 is formed of the engagement pin 4d and the pair of engagement recesses 15f.

As shown in FIG. 4A, when the pinion gear 15 is positioned in the transmitting position, the engagement pin 4d engages with the engagement recesses 15f, and the rotational force of the handle 5 is transmitted to the spool 3. On the other hand, as shown in FIG. 4B, when the pinion gear 15 is positioned in the disengaged position, the engagement pin 4d is disengaged from the engagement recess 15f, and the rotational force of the handle 5 is not transmitted to the spool 3.

The engagement and disengagement of the engagement pin 4d and the engagement recesses 15f are carried out by a clutch operating member 21 and the clutch control mechanism 22 shown in FIG. 2. As shown in FIG. 2, the clutch operating member 21 is disposed at the rear of the reel body 2.

As shown in FIG. 2, the clutch control mechanism 22 is disposed between the clutch operating member 21 and the pinion gear 15. In addition, the clutch control mechanism 22 is disposed between the handle 5 and the pinion gear 15.

The clutch control mechanism 22 moves the pinion gear 15 between the transmitting position and the disengaged position. In other words, the clutch control mechanism 22 engages with the recess 15g (refer to FIGS. 4A and 4B) of the pinion gear 15 and moves the pinion gear 15 in the axial direction. Because the configuration of the clutch control mechanism 22 is the same as in the prior art, a description thereof has been omitted.

The operation of the pinion gear 15 will be described below. In a state in which the rotational force of the handle 5 is transmitted to the spool 3, the pinion gear 15 is positioned in the transmitting position, as shown in FIG. 4A. In this transmitting state, when an angler presses the clutch operating member 21, the pinion gear 15 moves, via the clutch control mechanism 22, from the transmitting position (refer to FIG. 4A) to the disengaged position (refer to FIG. 4B) in the axial direction. At this time, the first bearing 16a and the second bearing 16b move together with the pinion gear 15 toward the disengaged position, while respectively sliding with respect to the first sliding member 23 and the second sliding member 24.

In the disengaged state in which the rotational force of the handle 5 is not transmitted to the spool 3, the pinion gear 15 is positioned in the disengaged position, as shown in FIG. 4B. In this disengaged state, when an angler rotates the handle 5, the pinion gear 15 moves, via the clutch control mechanism 22, from the disengaged position to the transmitting position in the axial direction. At this time, the first bearing 16a and the second bearing 16b move together with the pinion gear 15 toward the transmitting position (refer to FIG. 4A), while respectively sliding with respect to the first sliding member 23 and the second sliding member 24.

In the dual bearing reel 100 having the configuration described above, when the pinion gear 15 moves between the transmitting position and the disengaged position, the first bearing 16a and the second bearing 16b move together with the pinion gear 15. Therefore, it is not necessary to provide a gap between the outer circumferential surface of the pinion gear 15, the second inner race 16b1 of the second bearing 16b, and the first inner race 16a1 of the first bearing 16a.

Therefore, it is possible to prevent electrolytic water, such as salt water, from entering between the outer circumferential surface of the pinion gear 15, the second inner race 16b1 of the second bearing 16b, and the first inner race 16a1 of the first bearing 16a. That is, in the dual bearing reel 100, it is possible to prevent the outer circumferential surface of the pinion gear 15 and the first inner race 16a1 of the first bearing 16a, as well as the outer circumferential surface of the pinion gear 15 and the second inner race 16b1 of the second bearing 16b, from respectively adhering to each other. It is thereby possible to smoothly move the pinion gear 15.

In the dual bearing reel 100, the first sliding member 23 is disposed between the reel body 2 and the first outer race 16a2 of the first bearing 16a. The second sliding member 24 is disposed between the reel body 2 and the second outer race 16b2 of the second bearing 16b. As a result of this configuration, it is possible to smoothly move the first bearing 16a and the second bearing 16b together with the pinion gear 15.

In the dual bearing reel 100, since the first bearing 16a is provided at the first end 15d of the pinion gear 15 on the gear portion 15b side, the first bearing 16a moves in the axial direction together with the pinion gear 15 in a state of being adjacent to the gear portion 15b of the pinion gear 15. This allows the pinion gear 15 to rotate stably when the pinion gear 15 is positioned in the transmitting position.

In the dual bearing reel 100, since the second bearing 16b is provided at the second end portion 15e of the pinion gear 15 on the transmission portion 15c side, the pinion gear can be stably rotated by the first bearing 16a and the second bearing 16b.

One embodiment of the present disclosure is described above, but the present disclosure is not limited to the above-described embodiment, and various modifications can be made without departing from the scope of the disclosure. In addition, the following modified examples can be combined in any given manner as necessary.

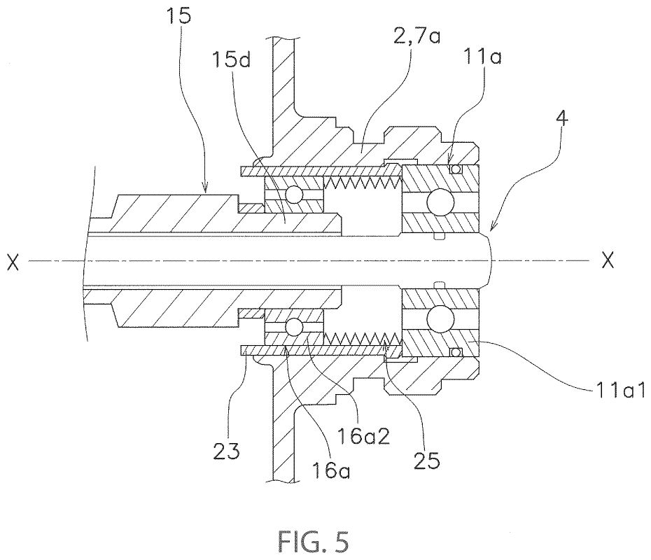

As shown in FIG. 5, the dual bearing reel 100 can further comprise a biasing member 25. FIG. 5 shows a case in which the pinion gear 15 is positioned in the transmitting position. In the present modified example, when the first bearing 16a moves together with the pinion gear 15, the biasing member 25 biases the first bearing 16a. In this modified example, the retaining member 18 of the above embodiment is omitted. Even if the retaining member 18 is omitted, the biasing member 25 biases the first bearing 16a, so that the first bearing 16a can be moved together with the pinion gear 15.

The biasing member 25 biases the first outer race 16a2 of the first bearing 16a in the axial direction (left direction in FIG. 5) from the disengaged position toward the transmitting position. More specifically, the biasing member 25 biases the first bearing 16a such that the first bearing 16a follows the movement of the pinion gear 15 when the pinion gear 15 moves from the disengaged position to the transmitting position. In the present embodiment, the biasing member 25 is a coil spring.

In a state in which the pinion gear 15 is disposed in the transmitting position, the coil spring 25 is in the compressed state and is disposed between an outer race 11a1 of a bearing 11a and the first outer race 16a2 of the first bearing 16a in the axial direction. As a result, when the pinion gear 15 moves from the disengaged position to the transmitting position, the biasing member (i.e., the coil spring) 25 biases the outer race 16a2 of the first bearing 16a in the direction in which the pinion gear 15 moves. As a result, in the dual bearing reel 100, it is possible to smoothly move the first bearing 16a together with the pinion gear 15.

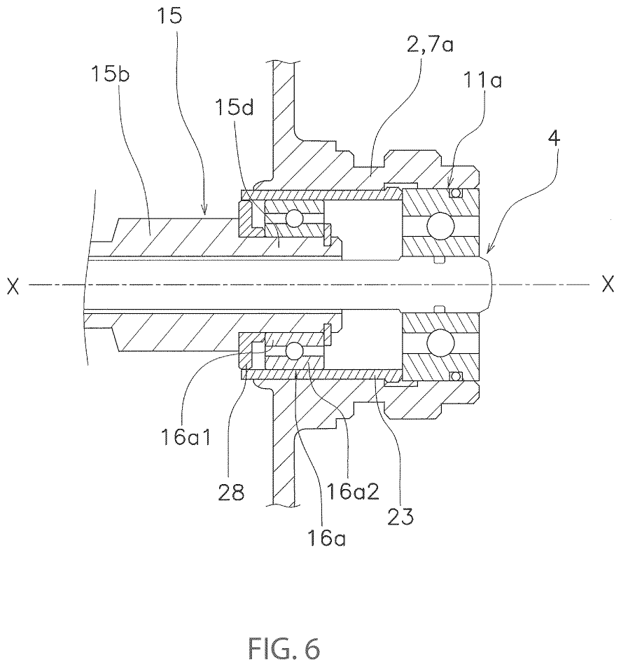

As shown in FIG. 6, the dual-bearing reel 100 can comprise a waterproofing member 28. FIG. 6 shows a case in which the pinion gear 15 is positioned in the transmitting position. The waterproofing member 28 prevents ingress of water into the first bearing 16a. The waterproofing member 28 is provided on the outer circumferential surface of the pinion gear 15. Specifically, the waterproofing member 28 is provided on the outer circumferential surface of the first end portion 15d of the pinion gear 15. The waterproofing member 28 is disposed between the first bearing 16a and the gear portion 15b in the axial direction.

Specifically, the waterproofing member 28 is formed in an annular shape. The inner circumferential portion of the waterproofing member 28 is disposed between the gear portion 15b and the first inner race 16a1 of the first bearing 16a in the axial direction. The outer circumferential portion of the waterproofing member 28 is disposed between the gear portion 15b and the first outer race 16a2 of the first bearing 16a in the axial direction. The outer circumferential portion of the waterproofing member 28 is disposed radially inward of the first sliding member 23. As a result, in the dual bearing reel 100, it is possible to prevent ingress of water into the inside of the first bearing 16a, allowing the first bearing 16a to smoothly rotate.

What is claimed is:

1. A dual bearing reel, comprising
a reel body;
a handle rotatably supported by the reel body;
a spool shaft rotatably supported by the reel body;
a spool configured to integrally rotate with the spool shaft;
a pinion gear configured to move between a transmitting position to transmit a rotational force of the handle to the spool shaft and a disengaged position to prevent transmission of the rotational force of the handle to the spool shaft;
a clutch control mechanism configured to move the pinion gear between the transmitting position and the disengaged position; and
a bearing rotatably supporting the pinion gear relative to the reel body and configured to move together with the pinion gear when the pinion gear moves between the transmitting position and the disengaged position.

2. The dual-bearing reel according to claim 1, further comprising
a sliding member disposed between the reel body and the bearing.

3. The dual-bearing reel according to claim 1, further comprising
a biasing member configured to bias the bearing when the bearing moves together with the pinion gear.

4. The dual-bearing reel according to claim 1, further comprising
a waterproofing member provided on the pinion gear and configured to prevent ingress of water into the bearing.

5. The dual-bearing reel according to claim 1, wherein
the bearing comprises
an inner race supported by the pinion gear,
an outer race slidably supported relative to the reel body when the pinion gear
moves between the transmitting position and the disengaged position, and rolling elements provided between the inner race and the outer race and supporting the inner race and the outer race so as to be rotatable relative to each other.

6. The dual-bearing reel according to claim 5, further comprising
a sliding member that is disposed between the reel body and the outer race of the bearing.

7. The dual-bearing reel according to claim 5, further comprising
a biasing member configured to bias the outer race of the bearing, in a direction from the disengaged position toward the transmitting position, when the bearing moves together with the pinion gear.

8. The dual-bearing reel according to claim 1, wherein
the pinion gear comprises
a gear portion to which the rotational force of the handle is transmitted when positioned in the transmitting position, and
a transmission portion configured to transmit the rotation of the pinion gear to the spool shaft when positioned in the transmitting position, and
the bearing includes a first bearing provided at a first end of the pinion gear on a gear portion side.

9. The dual-bearing reel according to claim 1, wherein
the pinion gear comprises
a gear portion to which the rotational force of the handle is transmitted when positioned in the transmitting position, and
a transmission portion configured to transmit the rotation of the pinion gear to the spool shaft when positioned in the transmitting position, and
the bearing includes a second bearing provided at a second end of the pinion gear on a transmission portion side.
